(19) United States
(12) Patent Application Publication
(10) Pub. No.: US 2008/0012892 A1
(43) Pub. Date: Jan. 17, 2008

(54) PRINTING APPARATUS, INFORMATION PROCESSING APPARATUS, CONTROL METHOD THEREFOR, PRINTING SYSTEM, AND PROGRAM

(75) Inventor: Takashi Imoto, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/773,957

(22) Filed: Jul. 5, 2007

(30) Foreign Application Priority Data
Jul. 7, 2006 (JP) 2006-188694

(51) Int. Cl. B41J 29/393; G08B 21/00

(52) U.S. Cl. 347/19; 340/679

(57) ABSTRACT

When the condition information of a printing apparatus contains a plurality of error/warning information, the printing apparatus determines the priority orders of the error/warning information and whether the plurality of error/warning information are to be notified, based on the print setting information of input print data. Based on the determination result, the printing apparatus generates status information which contains the plurality of error/warning information, their priority order and notification necessary/unnecessary information representing whether the plurality of error/warning information are to be notified. The printing apparatus displays display information corresponding to the error/warning information on the display unit, based on the plurality of error/warning information, their priority orders and the notification necessary/unnecessary information in the generated status information.

### BACKGROUND OF THE INVENTION

1. Field of the Invention

The present invention relates to a printing system including a printing apparatus which prints based on input print data and an information processing apparatus which generates print data to be supplied to the printing apparatus, the printing apparatus, the information processing apparatus, and a program.

2. Description of the Related Art

Conventionally, when a certain abnormality occurs in a printing apparatus, the printing apparatus or an information processing apparatus connected to the printing apparatus notifies a user of warning information and information used to solve the abnormal condition. When one abnormality occurs in the printing apparatus, the printing apparatus needs to display only the abnormality on the display unit of the printing apparatus. However, when a plurality of abnormalities simultaneously occur, various methods are available to notify the user of the abnormalities. For example, Japanese Patent Laid-Open No. 09-030092 discloses an arrangement in which when a plurality of abnormalities simultaneously occur, a user is sequentially notified of the abnormalities in descending order of priority. Also, Japanese Patent Laid-Open No. 2004-348376 discloses an arrangement in which a plurality of abnormalities are displayed as a list.

However, for example, the following problems occur in the above-described prior arts.

Redundant User Operation (Priority Order Display)

When a plurality of errors capable of being canceled by the same method simultaneously occur, a user must execute a redundant operation since the user is sequentially notified of the errors although the errors can be simultaneously canceled.

Assume that black and yellow ink tanks become empty at the same time. In this case, when a user is sequentially notified of “no black ink” “no yellow ink” in descending order of priority, the user undesirably repeats the same process twice in order to cancel the “no ink” errors.

### SUMMARY OF THE INVENTION

The present invention has been made to solve the above-described problems, and has as its object to provide a printing apparatus and information processing apparatus which can properly and effectively notify a user of a plurality of notification information, a control method therefor, a printing system, and a program.

According to first aspect of the present invention, a printing apparatus which prints based on input print data, comprises:

acquisition means for acquiring condition information of the printing apparatus;

determination means for, when the condition information acquired by the acquisition means contains a plurality of warning information, determining priority orders of the plurality of warning information and whether the plurality of warning information are to be notified;

generation means for, based on a determination result obtained by the determination means, generating status information representing a current condition of the printing apparatus, which contains the plurality of warning information, their priority orders and notification necessary/unnecessary information representing whether the plurality of warning information are to be notified; and

display control means for displaying display information corresponding to the plurality of warning information on a display unit, based on the plurality of warning information, the priority orders and the notification necessary/unnecessary information in the status information generated by the generation means.

In a preferred embodiment, wherein the display control means displays, on the display unit, the display information corresponding to the plurality of warning information to be notified in accordance with their priority order, among the plurality of warning information in the status information generated by the generation means.

In a preferred embodiment, when the condition information acquired by the acquisition means is updated, the generation means updates a content of the status information in accordance with the updated condition information.

In a preferred embodiment, based on print setting information of the input print data, the determination means determines that warning information to be canceled in order to continue a print process of the print data is warning information to be notified.

In a preferred embodiment, after the print process of the input print data ends, the generation means resets warning information which is not to be notified and is contained in the status information to warning information to be notified.

In a preferred embodiments the determination means determines the priority orders of the plurality of warning information and whether the plurality of warning information are to be notified, based on the priority order and the print setting information of the input print data for each type of warning information stored in a storage unit.

In a preferred embodiment, the apparatus further comprises:

storing means for storing the status information; and

transmission means for transmitting the status information to an information processing apparatus which has generated the input print data.

In a preferred embodiment, further comprises update means for, upon detecting that an error corresponding to warning information displayed on the display unit has been canceled, determining again warning information to be notified based on the priority orders of the plurality of warning information, whether the plurality of warning information are to be notified, and the number of errors capable of being displayed on the display unit, and updating display on the display unit based on the determination result.

According to the second aspect of the present invention, an information processing apparatus which generates print data to be supplied to a printing apparatus, comprises:

transmission means for transmitting the print data to the printing apparatus;

reception means for receiving status information which contains a plurality of warning information of the printing apparatus, their priority orders and notification necessary/unnecessary information representing whether the plurality of warning information are to be notified, as status information which represents a current condition of the printing apparatus for the print data; and

display control means for displaying, on the display unit, display information corresponding to the plurality of warning information, based on the plurality of warning information, the priority orders and the notification necessary/unnecessary information in the status information received by the reception means.

In a preferred embodiment, the display control means displays, on the display unit, the display information corresponding to the plurality of warning information to be notified in accordance with their priority order among the plurality of warning information in the status information.

In a preferred embodiment, the apparatus further comprises update means for, upon detecting that an error corresponding to warning information displayed on the display unit has been canceled, determining again warning information to be notified based on the priority orders of the plurality of warning information, whether the plurality of warning information are to be notified, and the number of errors capable of being displayed on the display unit, and updating display on the display unit based on the determination result.

According to third aspect of the present invention, a printing system including a printing apparatus which prints based on input print data, and an information processing apparatus which generates the print data to be supplied to the printing apparatus, wherein

the printing apparatus comprises

acquisition means for acquiring condition information of the printing apparatus,

determination means for, when the condition information acquired by the acquisition means contains a plurality of warning information, determining priority orders of the plurality of warning information and whether the plurality of warning information are to be notified,

generation means for, based on a determination result obtained by the determination means, generating status information representing a current condition of the printing apparatus, which contains the plurality of warning information, their priority orders and notification necessary/unnecessary information representing whether the plurality of warning information are to be notified, and

first display control means for displaying display information corresponding to the plurality of warning information on a display unit, based on the plurality of warning information, the priority and the notification necessary/unnecessary information in the status information generated by the generation means, and

the information processing apparatus comprises

transmission means for transmitting the print data to the printing apparatus,

reception means for receiving the status information which contains the plurality of warning information of the printing apparatus, their priority orders and the notification necessary/unnecessary information representing whether the plurality of warning information are to be notified, as status information which represents a current condition of the printing apparatus for the print data, and

second display control means for displaying, on the display unit, display information corresponding to the plurality of warning information, based on the plurality of warning information, the priority orders and the notification necessary/unnecessary information in the status information received by the reception means.

According to fourth aspect of the present invention, a control method for a printing apparatus which prints based on input print data, comprises:

an acquisition step of acquiring condition information of the printing apparatus;

a determination step of, when the condition information acquired in the acquisition step contains a plurality of warning information, determining priority orders of the plurality of warning information and whether the plurality of warning information are to be notified;

a generation step of, based on a determination result obtained in the determination step, generating status information representing a current condition of the printing apparatus, which contains the plurality of warning information, their priority orders and notification necessary/unnecessary information representing whether the plurality of warning information are to be notified; and

a display control step of displaying display information corresponding to the plurality of warning information on a display unit, based on the plurality of warning information, the priority orders and the notification necessary/unnecessary information in the status information generated in the generation step.

In a preferred embodiment, wherein in the display control step, the display information corresponding to the plurality of warning information to be notified in accordance with their priority order, among the plurality of warning information in the status information generated in the generation step is displayed on the display unit.

According to the fifth aspect of the present invention, a control method for an information processing apparatus which generates print data to be supplied to a printing apparatus, comprises:

a transmission step of transmitting the print data to the printing apparatus;

a reception step of receiving status information which contains a plurality of warning information of the printing apparatus, their priority orders and notification necessary/unnecessary information representing whether the plurality of warning information are to be notified, as status information which represents a current condition of the printing apparatus for the print data; and

a display control step of displaying, on the display unit, display information corresponding to the plurality of warning information, based on the plurality of warning information, the priority orders and the notification necessary/unnecessary information in the status information received in the reception step.

Further features of the present invention will be apparent from the following description of exemplary embodiments with reference to the attached drawings.

### BRIEF DESCRIPTION OF THE DRAWINGS

FIG. 1 is a block diagram showing an arrangement of a printing system according to an embodiment of the present invention;

FIG. 2 is a view showing a data configuration stored in the external storage device of a host computer according to the embodiment of the present invention;

FIG. 3 is a flowchart showing a status information generation process in which a status management program of a printer generates status information according to the embodiment of the present invention;

FIGS. 4A to 4E are views showing examples of various information processed by a status management program 24a according to the embodiment of the present invention;

FIG. 5 is a flowchart showing an error/warning display process in which a status information display program displays error/warning information on a display unit according to the embodiment of the present invention;

FIG. 6 is a view showing an example of a display window displayed on the display unit of the host computer according to the embodiment of the present invention;

FIGS. 7A and 7B are views showing other examples of the display window displayed on the display unit of the host computer according to the embodiment of the present invention;

FIG. 8 is a flowchart showing an error/warning display process in which a display control program of the printer displays error/warning information on the display unit according to the embodiment of the present invention;

FIG. 9 is a view showing another example of the display window displayed on the display unit of the printer according to the embodiment of the present invention;

FIGS. 10A to 10C are flowcharts showing examples of the condition change of the status information and the condition change of the contents displayed on the display units of the host computer and the printer, in accordance with the condition change of the printer according to the embodiment of the present invention; and

FIG. 11 is a view showing an example of the content displayed on the display unit of the printer in an initial condition according to the embodiment of the present invention.

### DESCRIPTION OF THE EMBODIMENTS

A preferred embodiment of the present invention will now be described in detail with reference to the drawings. It should be noted that the relative arrangement of the components, the numerical expressions and numerical values set forth in these embodiments do not limit the scope of the present invention unless it is specifically stated otherwise.

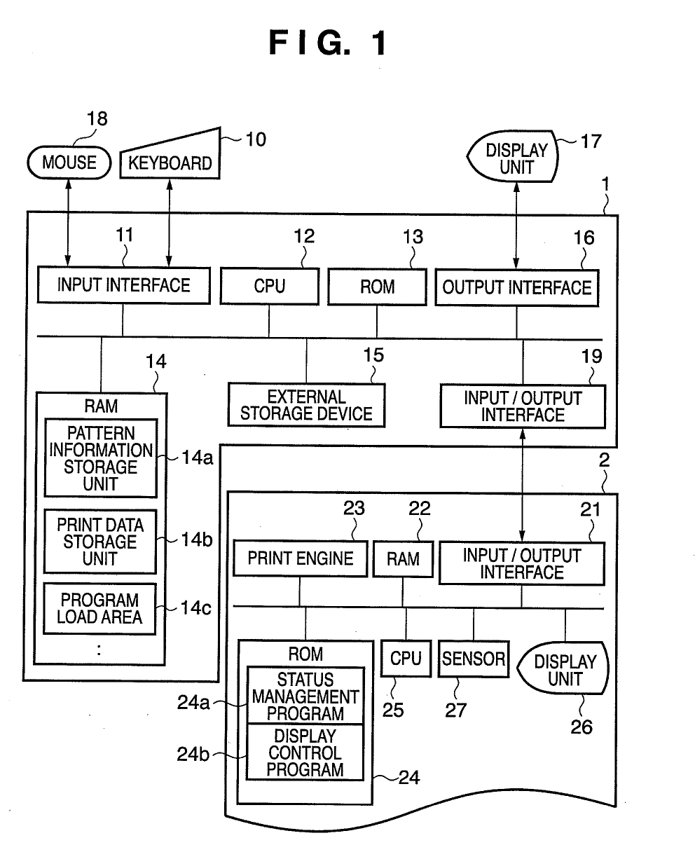

FIG. 1 is a block diagram showing an arrangement of a printing system according to the embodiment of the present invention.

FIG. 1 shows the printing system including a printer 2 and a host computer 1 connected to the printer 2.

The host computer 1 includes an input interface 11, CPU 12, ROM 13, RAM 14, external storage device 15, output interface 16, display unit 17, keyboard 10, mouse 18, and input/output interface 19.

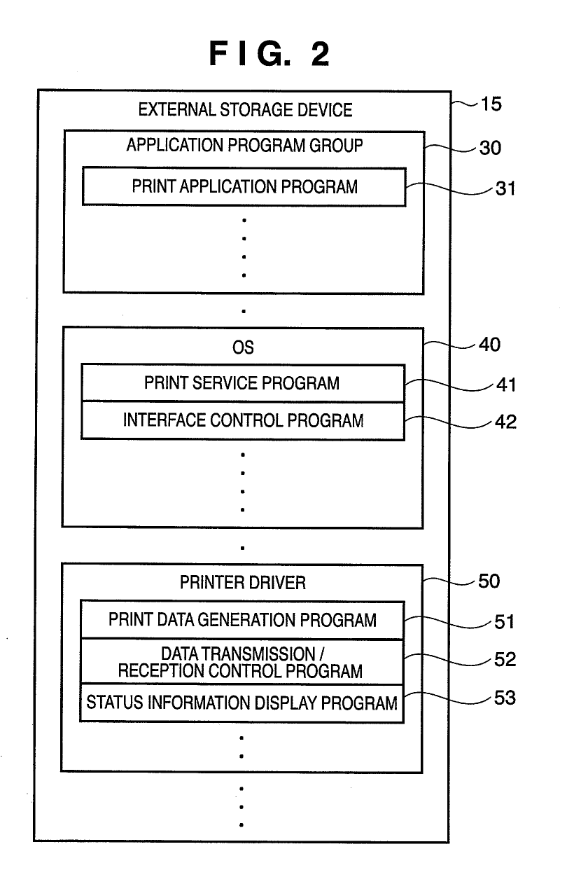

The ROM 13 stores various programs such as an initialization program. Referring to FIG. 2, the external storage device 15 stores an application program group 30, operation system (to be referred to as an OS hereinafter) 40, printer driver 50, and other various data. The external storage device 15 is implemented by a large-capacity storage device such as a hard disk.

Various programs stored in the external storage device 15.use the RAM 14 as a work memory. The RAM 14 ensures various storing areas. These storing areas comprise a pattern information storage unit 14a which stores pattern information such as font information and bitmap information, a print data storage unit 14b which stores print data to be supplied to the printer 2, and a program load area 14c for loading and executing programs.

The CPU 12 controls the constituent components of the host computer 1 in accordance with the various control programs stored in the ROM 13 and the external storage device 15.

The printer 2 includes an input/output interface 21, a RAM 22, a print engine 23, a ROM 24, a CPU 25, a display unit 26, and various sensors 27. The input/output interface 21 is connected to the input/output interface 19 of the host computer 1.

Various input/output interfaces such as Centronics parallel interface, USB, SCSI, IEEE1394, and LAN can serve as the input/output interfaces 19 and 21. The type of input/output interface is not limited to these examples, and any input/output interface can be adopted as long as the printer 2 and the host computer 1 can communicate with each other. Also, an extended option which extends the function (e.g., a finishing device or an extended fontboard) of the printer 2 can be connected to the input/output interface 21.

In this embodiment, the printer 2 serving as the printing apparatus is a color inkjet printer of an inkjet method using, e.g., cyan, magenta, yellow, and black inks. However, the present invention is not limited to this. The printer 2 may be a color laser beam printer of an electrophotographic method using the same color toner, or a printer of another print method (e.g., a thermal transfer method).

The RAM 22 serves as the main memory and work memory of the CPU 25, and stores a reception buffer and various data for temporarily storing received print data. The print engine 23 prints based on print data stored in the RAM 22.

The ROM 24 stores various control programs such as a status management program 24a and a display control program 24b, and data used by the various control programs. The CPU 25 controls the constituent components of the printer 2 in accordance with the various control programs stored in the ROM 24. The status management program 24a is a program which monitors the condition of the printer 2 on the basis of sensor information obtained from the various sensors 27 in the printer 2, generates status information based on the monitor result, and stores it in the RAM 22. The display control program 24b is a program which controls the display unit 26 to display the condition of the printer 2 on the display unit 26 based on the status information stored in the RAM 22.

The various sensors 27 comprise sensors for detecting the various conditions of the printer 2. For example, as the sensors, a sensor which detects the presence/absence of ink, a sensor which detects the presence/absence of a printing medium (printing paper), a sensor which detects the open/close state of the cover of the printer 2, a sensor which detects a paper jam, and a sensor which detects an abnormality of the print engine 23 are available.

Note that, to simplify the explanation, the display unit 26 can display only warning information as notification information, and a displayable information count is limited to one. That is, for example, the display unit 26 comprises an LCD with a comparatively simple arrangement so as to display character information for at least one line. Of course, the display unit may display character information for a plurality of lines depending on the specification of the printer 2.

The warning information is information used to notify a user or administrator that the printer is in a specific processing condition, or that hardware is in a specific condition. The warning information contains alert information representing that the remaining amount of paper is small, and information representing that a paper feed tray is empty. The warning information also contains error information representing a paper jam, job error, or the like. The warning information also contains information for notifying the user of a specific condition such as job interruption.

The data configuration stored in the external storage device 15 of the host computer 1 will be described next with reference to FIG. 2.

FIG. 2 is a view showing the data configuration stored in the external storage device of the host computer according to the embodiment of the present invention.

As described above, the external storage device 15 stores the application program group 30, OS 40, printer driver 50, and the like. Of these software programs, the application program group 30 includes various applications such as a print application program 31 which allows the user to draw/print pattern information (image) to be printed by the printer 2.

The OS 40 installs various service programs prepared by an OS. The service programs include, e.g., a print service program 41 which provides a print environment, and an interface control program 42 which manages the physical I/O port of the host computer 1 to control the input/output interface 19.

The printer driver 50 installs a print data generation program 51, data transmission/reception control program 52, status information display program 53, and the like.

When the print application program 31 performs printing, the print service program 41 activates the print data generation program 51. The print data generation program 51 then converts pattern information generated by the print application program 31 into a print command to generate print data.

The data transmission/reception control program 52 is a program for performing two-way communication with the printer 2 via the interface control program 42. The data transmission/reception control program 52 receives, from the print service program 41, the print data generated by the print data generation program 51, and transmits it to the printer 2 via the interface control program 42. The data transmission/reception control program 52 also acquires the status information representing the condition of the printer 2 via the interface control program 42. The acquired status information is sent to the status information display program 53.

The status information display program 53 displays the print job and the condition of the printer 2 on the display unit 17 based on the received status information and the print job information received from the print service program 41. Note that the print job is a unit of a print process executed by the printer 2, and contains various information such as print data and the print condition, print sequence, and print setting of the print data.

In this embodiment, for example, the host computer 1 and the printer 2 share the processes in the above-described method. However, the present invention is not limited to this, and another sharing method can be adopted.

The printing system shown in FIG. 1 has the following problems to be solved in addition to the problems described in “Problem That the Invention Is to Solve”.

Change of Notification Content during Operation (Priority Order Display)

While the user performs an error cancel operation, if a new error/warning occurs upon changing the condition of the printing apparatus, the notification content changes before the first error cancel operation is completed.

For example, when an ink tank is to be replaced by opening the cover, the notification content changes from a “no ink” error the user opens the cover to replace the ink tank a “cover open” error.

Contradiction between Notification Contents (List Display)

A contradiction between the canceling methods may occur depending on the combination of errors.

Assume that an error A which is to be canceled by pressing a certain button mounted on the printing apparatus and an error B which disables the button occur at the same time. In this case, a contradiction occurs since the user is prompted to press the button although the button is disabled.

Unnecessary Notification (List Display)

The printing apparatus undesirably performs unnecessary notification for a user operation.

Assume that a certain error occurs in a paper feed tray A, but there is no problem in printing using a paper feed tray B. In this case, the printing apparatus performs unnecessary notification even to the user who prints using the paper feed tray B.

In order to solve these problems, it is also effective to “add priority order to error information, and switch a notification content depending on an error condition on a display unit”. However, the canceling method and priority order of an error generally change for each printing apparatus. Hence, a notification content determination method for each printing apparatus needs to be set on the display unit. In this case, the display units (the information processing apparatus and the printing apparatus) need to perform display without any contradiction. Also, all the display units need to display the notification contents without any problem in firmware version up processing by adding an option device or the like to the printing apparatus.

Therefore, in the present invention, an arrangement will be described, in which the display units (the information processing apparatus and the printing apparatus) perform status display without any contradiction when notifying the user of the condition display such as the above-described error/warning information. The characteristic feature of this arrangement is that a more proper condition display can be provided by adding, to status information, the priority order and notification necessary/unnecessary information of the status information such as the error/warning information.

As the characteristic arrangement which implements the present invention, the status display of the printer 2 will be described, which is implemented on the display unit 17 of the host computer 1 and the display unit 26 of the printer 2.

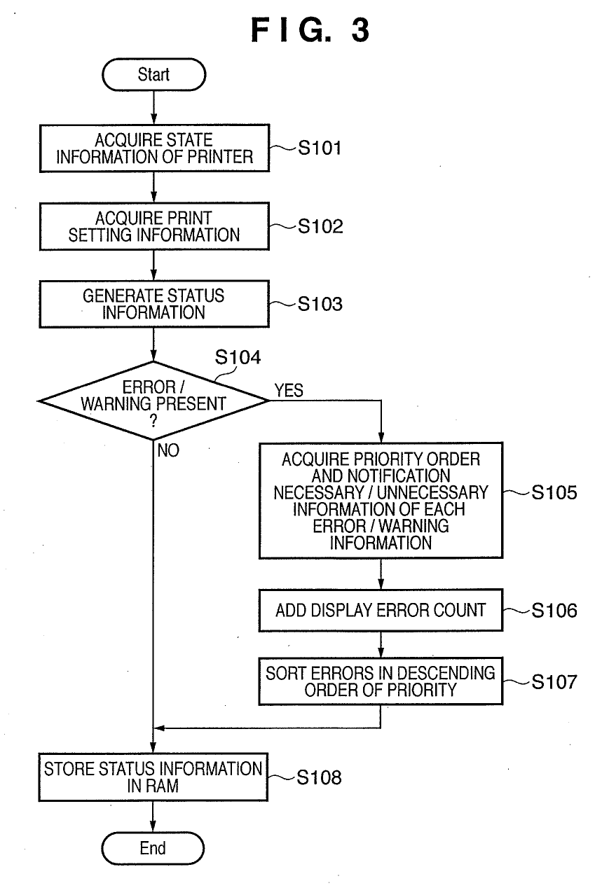

First, a status information generation process in which the status management program 24a of the printer 2 generates the status information will be described with reference to FIG. 3.

FIG. 3 is a flowchart showing the status information generation process in which the status management program of the printer generates status information according to the embodiment of the present invention.

Note that the CPU 25 controls to implement the status management program 24a.

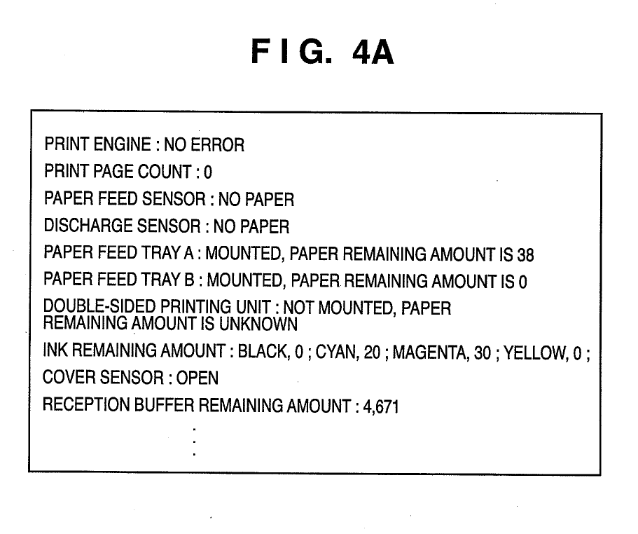

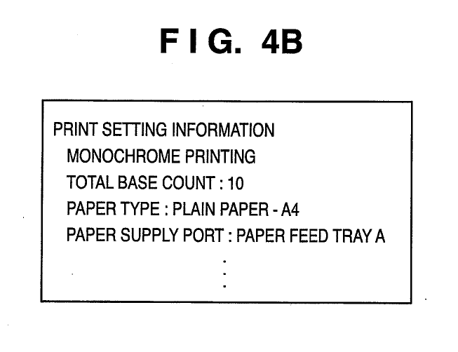

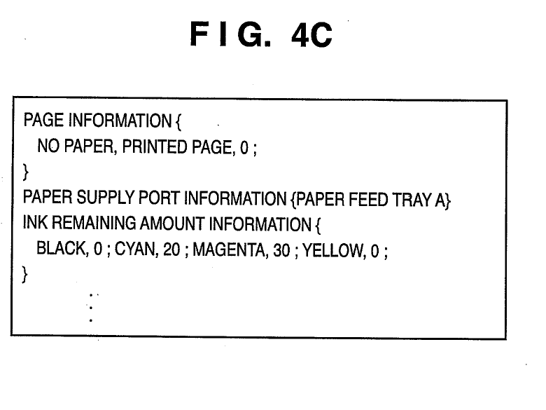

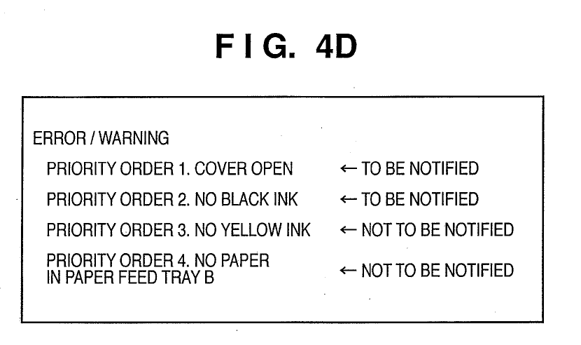

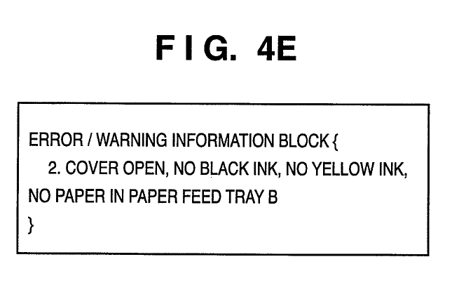

In step S101, the status management program 24a first checks the conditions of the various sensors 27 in the printer 2, and acquires the condition information of the printer 2. For example, this condition information shown in, e.g., FIG. 4A represents the condition of the print engine 23 and a printing paper sheet conveyance condition. Note that the status management program 24a may acquire this condition information periodically, or in response to notifications from the various sensors.

In step S102, the status management program 24a then acquires print setting information representing an instruction to print the print data. This print setting information shown in, e.g., FIG. 4B is contained in the print data transmitted from the host computer 1. Before transmitting the print data, this print setting information does not exist.

After that, based on the condition information and print setting information respectively acquired in steps S101 and S102, the status management program 24a generates the status information representing the current condition of the printer 2 in step S103. This status information shown in, e.g., FIG. 4C contains information blocks for respective statuses. FIG. 4C shows information blocks such as page information about a print page count, paper feed port information about a paper feed port, and remaining ink amount information about the amount of ink remaining.

In step S104, the status management program 24a then determines whether the generated status information contains the error/warning information. If the status information contains no error/warning information (NO in step S104), the process advances to step S108 to store the generated status information in the RAM 22, and the process ends. Note that the status information stored in the RAM 22 may be transmitted to the host computer 1 in response to a request from the host computer 1, or at a timing when the status information is stored in the RAM 22.

On the other hand, if the status information contains the error/warning information (YES in step S104), the process advances to step S105. In step S105, the status management program 24a acquires the priority order and notification necessary/unnecessary information for each error/warning represented in the error/warning information as shown in FIG. 4D. The priority order and the notification necessary/unnecessary information are stored in, e.g., the ROM 24 in advance, and determined based on the condition information of the printer 2, print data, and print setting information.

Of the notification necessary/unnecessary information, information to be notified is the minimum error/warning information to be canceled in order to continue the current print process. On the other hand, information not to be notified is the error/warning information which causes no trouble in the current print process but needs to be canceled soon or later.

For example, even if the condition information represents “no yellow ink” when the print setting information designates monochrome printing, no trouble occurs in printing. Hence, in such a case, it can be determined that the user need not be notified of the status information representing “no yellow ink” (notification is unnecessary).

Also, even if the condition information represents “no paper in paper feed tray B” when the print setting information designates the paper feed tray A, no trouble occurs in printing. Hence, in such case, it can be determined that the user need not be notified of the status information representing “no paper in paper feed tray B” (notification is unnecessary).

In step S106, based on the acquired priority order and the notification necessary/unnecessary information, the status management program 24a adds a display error count to the error/warning information block of the status information generated in step S103. More specifically, the number of error/warning information to be notified is added as the display error count. Referring to FIG. 4D, the information to be notified are “cover open” having a first priority order and “no black ink” having a second priority order. Accordingly, the display error count is 2.

In step S107, the status management program 24a then sorts the error/warning information in descending order of priority.

FIG. 4E shows an example of the sorted error/warning information blocks. The number at the first position in the braces { } indicates the display error count, and the following errors are arranged in descending order of priority. In this example, the number of errors to be notified to the user is 2, and the “cover open” error and “no black ink” error having a higher priority order are to be displayed. The remaining “no yellow ink” error and the “no paper in paper feed tray B” error need not be notified.

In step S108, the status management program 24a stores all status information with the rewritten error/warning information blocks in the RAM 22, and the process ends.

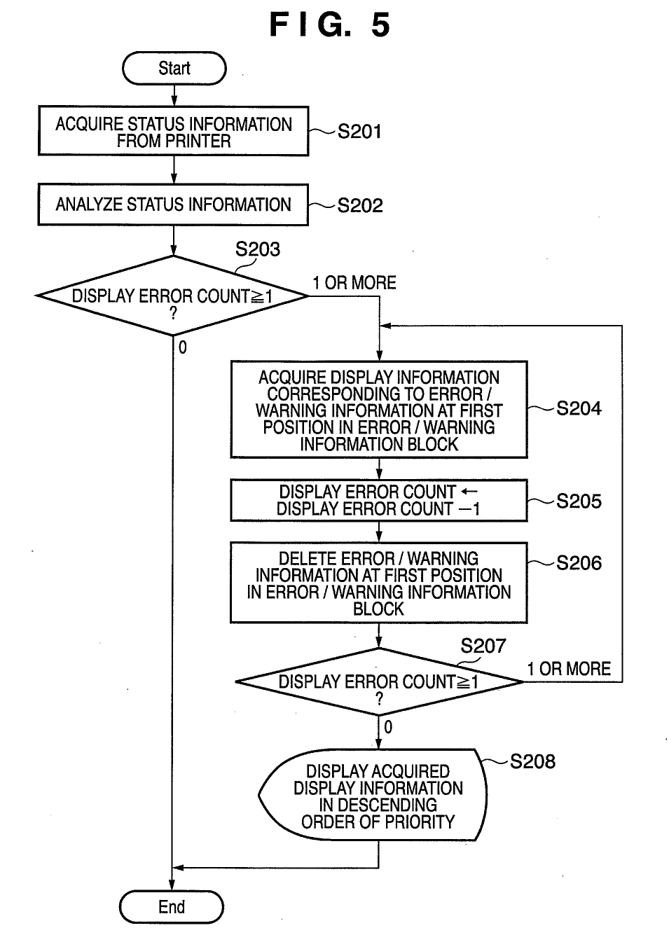

The error/warning display process will be described with reference to FIG. 5, in which the status information display program 53 of the host computer 1 displays the error/warning information on the display unit 17.

FIG. 5 is a flowchart showing the error/warning display process in which the status information display program displays the error/warning information on the display unit according to the embodiment of the present invention.

Note that the CPU 12 controls to implement the status information display program 53.

In step S201, the status information display program 53 first acquires the status information from the printer 2. In step S202, the status information display program 53 then analyzes the acquired status information. In step S203, the status information display program 53 checks the display error count of the error/warning information block in the status information. When the display error count is 0, there is no error/warning information to be notified, and the error/warning display process ends.

On the other hand, when the display error count is 1 or more, the process advances to step S204, and the status information display program 53 acquires the display information corresponding to the error/warning information at the first position in the error/warning information block.

In step S205, the status information display program 53 then decrements the display error count by one. In step S206, the status information display program 53 then deletes the error/warning information at the first position in the error/warning information block.

In step S207, the status information display program 53 checks the display error count again. When the display error count is 0, the process advances to step S208. On the other hand, when the display error count is 1 or more, the process returns to step S204.

In step S208, the status information display program 53 displays one or more display information acquired in step S204 on the display unit 17 in descending order of priority.

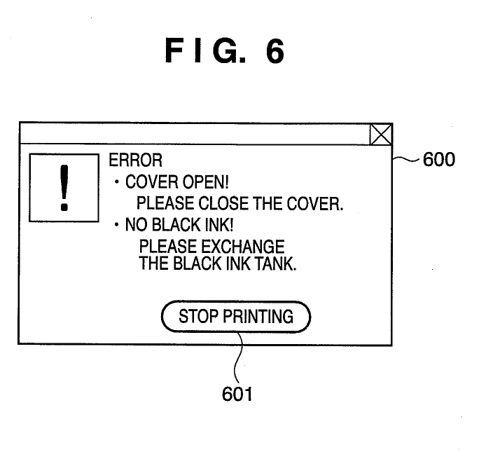

FIG. 6 shows an example of a display window which displays the display information. A display window 600 shown in FIG. 6 displays the error/warning information downward in descending order of priority on the display unit 17. The error/warning information contains the error/warning content and canceling method written in a text string. However, an image for guiding the canceling method may be displayed as needed.

The display window 600 displays a print stop button 601, and the user can stop printing by operating the mouse 18 and the keyboard 10 as needed.

Note that this display window is merely an example. For example, the display size of the error/warning information may increase in descending order of priority. Alternatively, the display color density of the error/warning information may increase in descending order of priority. That is, any display format can be adopted as long as the error/warning information having a higher priority order receives a greater deal of attention from the user.

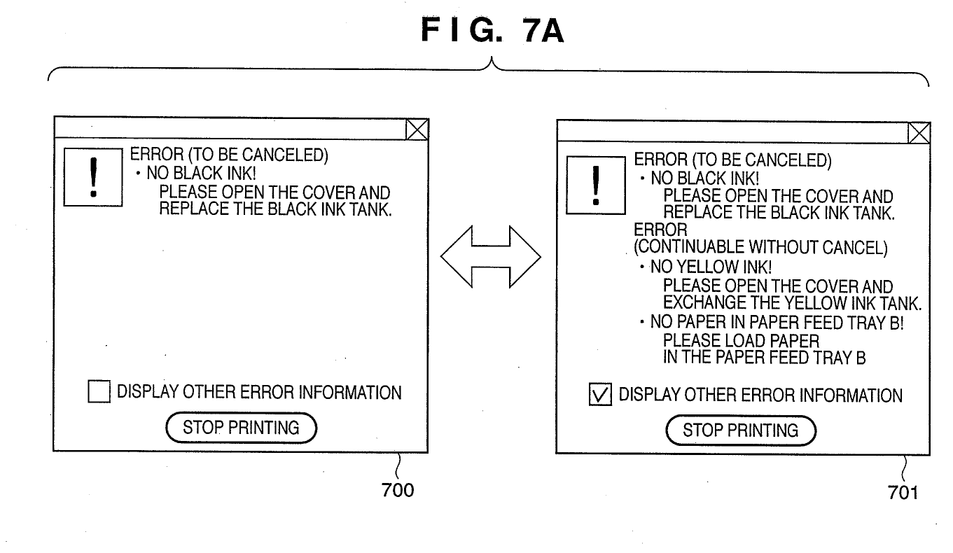

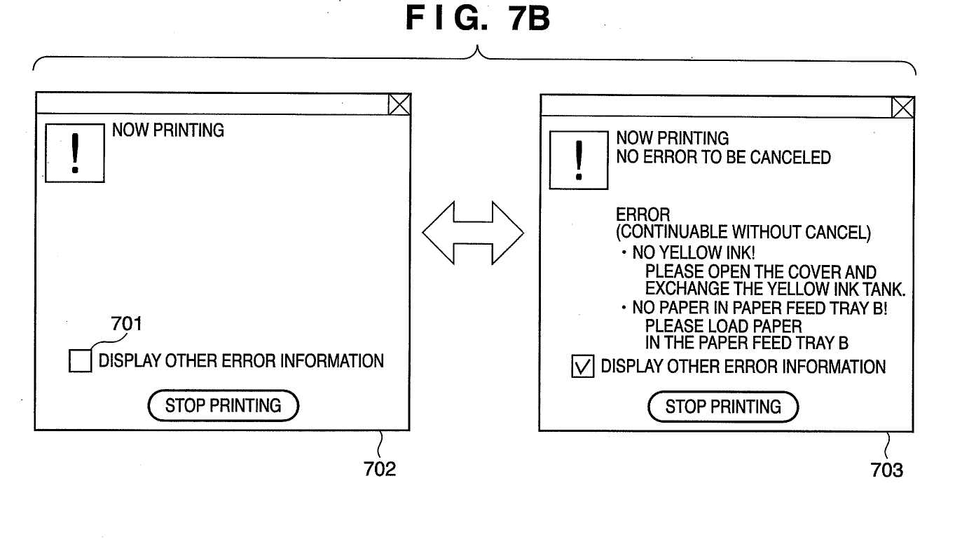

Although not described in this embodiment, for example, the status information display program 53 may also display the error/warning information not to be notified. FIGS. 7A and 7B show the examples of the display window in this case. Display windows 700 and 702 shown in FIGS. 7A and 7B include check boxes. If the check boxes are not checked, the display windows 700 and 702 display only the error/warning information to be notified (canceled). On the other hand, if the check boxes are checked, display windows 701 and 703 display both the error/warning information to be notified and the error/warning information not to be notified.

As described above, on the display windows shown in FIGS. 7A and 7B, the minimum error/warning information to be canceled in order to continue the current print process is notified, and the user can check, as needed, the error/warning information which causes no trouble in the current print process but needs to be canceled soon or later.

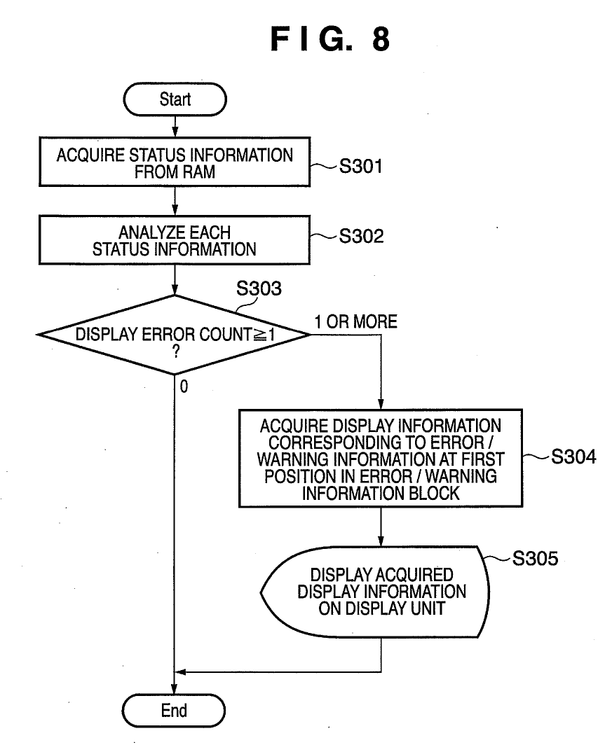

The error/warning display process will be described with reference to FIG. 8, in which the display control program 24b of the printer 2 displays the error/warning information on the display unit 26.

FIG. 8 is a flowchart showing the error/warning display process in which a display control program of the printer displays error/warning information on the display unit according to the embodiment of the present invention.

Note that the CPU 25 controls to implement the status management program 24a.

In step S301, the display control program 24b acquires, from the RAM 22, the status information generated by the status management program 24a. The display control program 24b then analyzes the status information, and detects the error/warning information block in the status information. In step S303, the display control program 24b checks the display error count of the error/warning information block. If the display error count is 0, there is no error/warning information to be notified, and the error/warning display process ends.

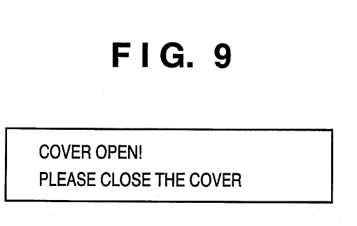

On the other hand, when the display error count is 1 or more, the process advances to step S304, and the display control program 24b acquires the display information corresponding to the error/warning information at the first position in the error/warning information block. In step S305, the display control program 24b displays the acquired display information on the display unit 26. Since the display unit 26 can display only one error/warning information as described above, the display unit 26 displays the display information acquired in step S304 as shown in FIG. 9, and the process ends.

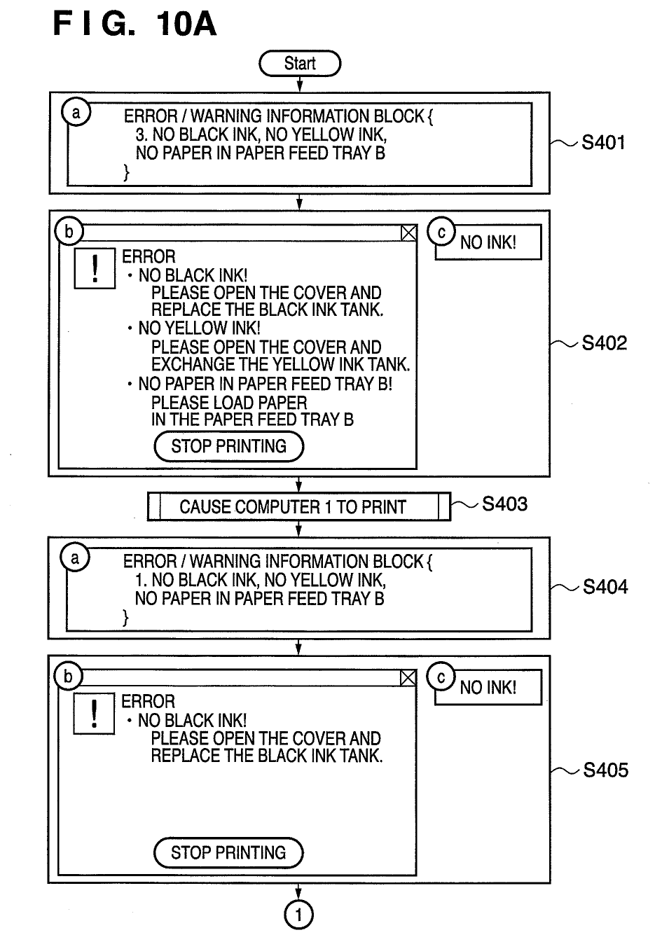

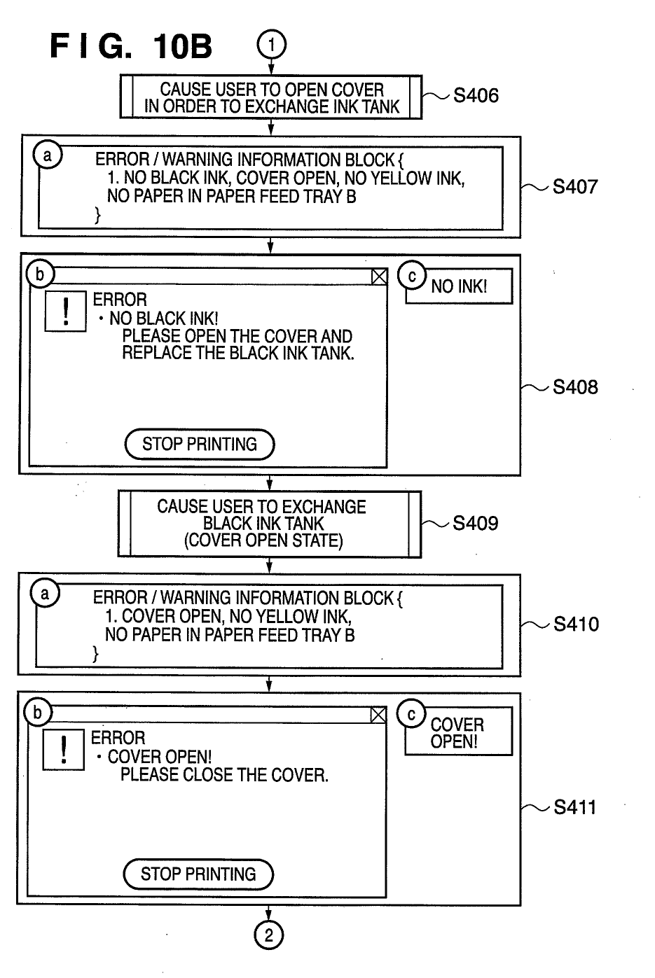

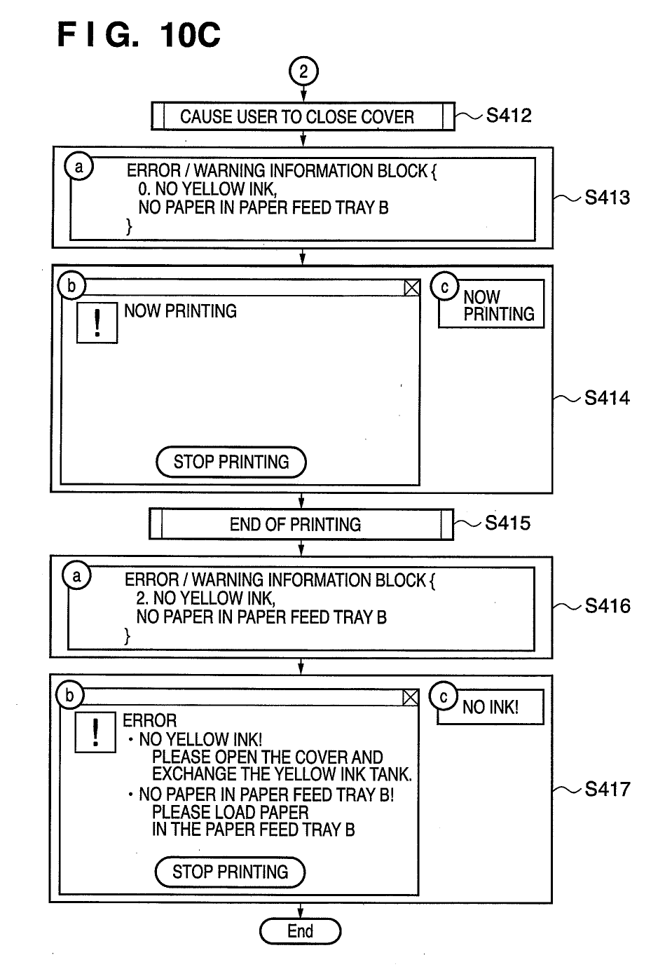

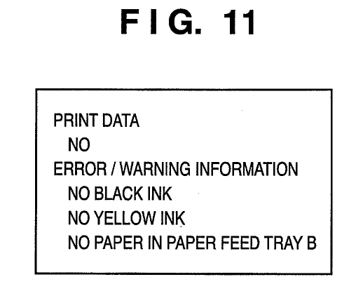

In accordance with the condition change of the printer 2, the operations of the status management program 24a, display control program 24b, and display unit 26 of the printer 2, and the status information display program 53 and display unit 17 of the host computer 1 will be described below with reference to FIGS. 10A to 10C and FIG. 11.

In the flowcharts shown in FIGS. 10A to 10C, reference symbol a denotes the error/warning information block of the status information stored in the RAM 22 by the status management program 24a according to the flowchart shown in FIG. 3. Reference symbol b denotes the content displayed on the display unit 17 by the status information display program 53 according to the flowchart shown in FIG. 5. Reference symbol c denotes the content displayed on the display unit 26 by the display control program 24b according to the flowchart shown in FIG. 8.

When the printer 2 is in the condition shown in FIG. 11, the status management program 24a generates the status information as shown in step S401. The status information display program 53 and the display control program 24b perform display as shown in step S402 on the display units 17 and 26 according to the status information.

In step S403, the host computer 1 starts the print process in accordance with the print setting information (monochrome printing, total page count=10, plain paper, paper feed tray A, and the like) shown in FIG. 4B.

In step S404, the status management program 24a generates new status information containing the received print data. In this case, since a paper sheet in the paper feed tray A is used in monochrome printing, the “no yellow ink” error and “no paper in paper feed tray B” error of the generated errors need not be notified. Accordingly, the status information display program 53 and the display control program 24b perform display as shown in step S405 on the display units 17 and 26.

When the printer 2 detects in step S406 that the user has opened the cover of the printer 2 (cover open), a new “cover open” error is generated. Since the ink tank has not been replaced yet, it is determined in step S407 that this “cover open” error need not be notified. In this case, the status management program 24a generates status information by adding the “cover open” error to the status information shown in step S404. In step S408, the status information display program 53 and the display control program 24b perform display as shown in step S402 on the display units 17 and 26 according to the status information. In this case, since the “cover open” error in the generated status information need not be notified, the contents displayed on the display units 17 and 26 are the same as that displayed in step S405.

In step S409, the printer 2 detects that the black ink tank has been replaced. In step S410, the status management program 24a cancels the “no black ink” error, and generates the status information in which the “cover open” error having the second priority order is set as an error to be notified. Accordingly, in step S411, the status information display program 53 and the display control program 24b perform display as shown in step S411 on the display units 17 and 26 according to the status information. In this case, the “no black ink” error is switched to the “cover open” error on each of the display units 17 and 26.

When the printer 2 detects in step S412 that the user has closed the cover (cover close), only the “no yellow ink” error and the “no paper in paper feed tray B” error occur. Accordingly, it is determined in step S413 that these errors need not be notified in the current printing process. In this case, the status management program 24a generates status information by deleting the “cover open” error from the status information shown in step S410. In step S414, the status information display program 53 and the display control program 24b perform display as shown in step S414 on the display units 17 and 26 according to the status information. In this case, since the “no yellow ink” error and the “no paper in paper feed tray B” error in the generated status information need not be notified, the display units 17 and 26 display no error/warning information.

When printing ends in the printer 2 in step S415, the status management program 24a generates status information by setting the “no yellow inks error and the “no paper in paper feed tray B” error as the errors to be notified in step S416. In step S417, the status information display program 53 and the display control program 24b perform display as shown in step S417 on the display units 17 and 26 according to the status information.

The CPU 25 in the printer 2 detects that the error corresponding to the warning information displayed on the display unit 17 has been canceled. The CPU 25 then determines again the warning information to be notified, based on the priority order and notification necessary/unnecessary information of the warning information and the number of errors which can be displayed on the display unit 17. The CPU 25 in the printer 2 updates the display on the display unit 17 based on the determination result. Note that the CPU 12 of the host computer may perform the display and the error cancel detection process, and the display unit 17 of the host computer 1 may display the contents of these processes.

As described above, this embodiment has the following effects.

(1) When a plurality of errors/warnings occur, the printing system switches the notification necessary/unnecessary information of each error/warning based on the current condition, thereby preventing the notification content from being changed during operation.

(2) When a plurality of errors/warnings occur, the printing system switches the notification necessary/unnecessary information of each error/warning based on the current condition, thereby preventing a contradicting notification of an operation content.

(3) When a plurality of errors/warnings occur, the printing system switches the notification necessary/unnecessary information of each error/warning based on the current condition, thereby preventing an unnecessary error notification for a user operation.

(4) Since the printing apparatus acquires the priority order and notification necessary/unnecessary information of each error/warning, each display unit needs to have no information to determine a display content, and no display determination routine for each printing apparatus. Hence, a contradiction between the notification contents displayed on the display units can be prevented, and the maintenance processes of the display units can be simplified.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-188694 filed on Jul. 7, 2006, which is hereby incorporated by reference herein in its entirety.

What is claimed is:

1. A printing apparatus which prints based on input print data, comprising:
acquisition means for acquiring condition information of the printing apparatus;
determination means for, when the condition information acquired by said acquisition means contains a plurality of warning information, determining priority orders of said plurality of warning information and whether said plurality of warning information are to be notified;
generation means for, based on a determination result obtained by said determination means, generating status information representing a current condition of the printing apparatus, which contains said plurality of warning information, their priority orders and notification necessary/unnecessary information representing whether said plurality of warning information are to be notified; and
display control means for displaying display information corresponding to said plurality of warning information on a display unit, based on said plurality of warning information, said priority orders and said notification necessary/unnecessary information in the status information generated by said generation means.

2. The apparatus according to claim 1, wherein said display control means displays, on the display unit, the display information corresponding to said plurality of warning information to be notified in accordance with their priority order, among said plurality of warning information in the status information generated by said generation means.

3. The apparatus according to claim 1, wherein, when the condition information acquired by said acquisition means is updated, said generation means updates a content of the status information in accordance with the updated condition information.

4. The apparatus according to claim 1, wherein based on print setting information of the input print data, said determination means determines that warning information to be canceled in order to continue a print process of the print data is warning information to be notified.

5. The apparatus according to claim 1, wherein after the print process of the input print data ends, said generation means resets warning information which is not to be notified and is contained in the status information to warning information to be notified.

6. The apparatus according to claim 1, wherein said determination means determines the priority orders of said plurality of warning information and whether said plurality of warning information are to be notified, based on the priority order and the print setting information of the input print data for each type of warning information stored in a storage unit.

7. The apparatus according to claim 1, further comprising:
storing means for storing the status information; and
transmission means for transmitting the status information to an information processing apparatus which has generated the input print data.

8. The apparatus according to claim 1, further comprising update means for, upon detecting that an error corresponding to warning information displayed on the display unit has been canceled, determining again warning information to be notified based on the priority orders of said plurality of warning information, whether said plurality of warning information are to be notified, and the number of errors capable of being displayed on the display unit, and updating display on the display unit based on the determination result.

9. An information processing apparatus which generates print data to be supplied to a printing apparatus, comprising:
transmission means for transmitting the print data to the printing apparatus;
reception means for receiving status information which contains a plurality of warning information of the printing apparatus, their priority orders and notification necessary/unnecessary information representing whether said plurality of warning information are to be notified, as status information which represents a current condition of the printing apparatus for the print data; and
display control means for displaying, on the display unit, display information corresponding to said plurality of warning information, based on said plurality of warning information, said priority orders and said notification necessary/unnecessary information in the status information received by said reception means.

10. The apparatus according to claim 9, wherein said display control means displays, on the display unit, the display information corresponding to said plurality of warning information to be notified in accordance with their priority order among said plurality of warning information in the status information.

11. The apparatus according to claim 9, further comprising update means for, upon detecting that an error corresponding to warning information displayed on the display unit has been canceled, determining again warning information to be notified based on the priority orders of said plurality of warning information, whether said plurality of warning information are to be notified, and the number of errors capable of being displayed on the display unit, and updating display on the display unit based on the determination result.

12. A printing system including a printing apparatus which prints based on input print data, and an information processing apparatus which generates the print data to be supplied to the printing apparatus, wherein
the printing apparatus comprises
acquisition means for acquiring condition information of the printing apparatus,
determination means for, when the condition information acquired by said acquisition means contains a plurality of warning information, determining priority orders of said plurality of warning information and whether said plurality of warning information are to be notified,
generation means for, based on a determination result obtained by said determination means, generating status information representing a current condition of the printing apparatus, which contains said plurality of warning information, their priority orders and notification necessary/unnecessary information representing whether said plurality of warning information are to be notified, and
first display control means for displaying display information corresponding to said plurality of warning information on a display unit, based on said plurality of warning information, said priority and said notification necessary/unnecessary information in the status information generated by said generation means, and
the information processing apparatus comprises
transmission means for transmitting the print data to the printing apparatus,
reception means for receiving the status information which contains said plurality of warning information of the printing apparatus, their priority orders and the notification necessary/unnecessary information representing whether said plurality of warning information are to be notified, as status information which represents a current condition of the printing apparatus for the print data, and
second display control means for displaying, on the display unit, display information corresponding to said plurality of warning information, based on said plurality of warning information, said priority orders and said notification necessary/unnecessary information in the status information received by said reception means.

13. A control method for a printing apparatus which prints based on input print data, comprising:
an acquisition step of acquiring condition information of the printing apparatus;
a determination step of, when the condition information acquired in the acquisition step contains a plurality of warning information, determining priority orders of said plurality of warning information and whether said plurality of warning information are to be notified;
a generation step of, based on a determination result obtained in the determination step, generating status information representing a current condition of the printing apparatus, which contains said plurality of warning information, their priority orders and notification necessary/unnecessary information representing whether said plurality of warning information are to be notified; and
a display control step of displaying display information corresponding to said plurality of warning information on a display unit, based on said plurality of warning information, said priority orders and said notification necessary/unnecessary information in the status information generated in the generation step.

14. The method according to claim 13, wherein in the display control step, the display information corresponding to said plurality of warning information to be notified in accordance with their priority order, among said plurality of warning information in the status information generated in the generation step is displayed on the display unit.

15. The method according to claim 13, wherein, in the generation step, when the condition information acquired in the acquisition step is updated, a content of the status information is updated in accordance with the updated condition information.

16. The method according to claim 13, wherein in the determination step, based on print setting information of the input print data, warning information to be canceled in order to continue a print process of the print data is determined as warning information to be notified.

17. The method according to claim 13, wherein in the generation step, after the print process of the input print data ends, warning information which is not to be notified and is contained in the status information is reset to warning information to be notified.

18. The method according to claim 13, wherein in the determination step, the priority orders of said plurality of warning information and whether said plurality of warning information are to be notified are determined, based on the priority order and the print setting information of the input print data for each type of warning information stored in a storage unit.

19. The method according to claim 13, further comprising:
a storing step of storing the status information in a storing medium; and
a transmission step of transmitting the status information to an information processing apparatus which has generated the input print data.

20. The method according to claim 13, further comprising an update step of, upon detecting that an error corresponding to warning information displayed on the display unit has been canceled, determining again warning information to be notified based on the priority orders of said plurality of warning information, whether said plurality of warning information are to be notified, and the number of errors capable of being displayed on the display unit, and updating display on the display unit based on the determination result.

21. A control method for an information processing apparatus which generates print data to be supplied to a printing apparatus, comprising:
a transmission step of transmitting the print data to the printing apparatus;
a reception step of receiving status information which contains a plurality of warning information of the printing apparatus, their priority orders and notification necessary/unnecessary information representing whether said plurality of warning information are to be notified, as status information which represents a current condition of the printing apparatus for the print data; and
a display control step of displaying, on the display unit, display information corresponding to said plurality of warning information, based on said plurality of warning information, said priority orders and said notification necessary/unnecessary information in the status information received in the reception step.

22. The method according to claim 21, wherein in the display control step, the display information corresponding to said plurality of warning information to be notified in accordance with their priority order among said plurality of warning information in the status information is displayed on the display unit.

23. The method according to claim 21, further comprising an update step of, upon detecting that an error corresponding to warning information displayed on the display unit has been canceled, determining again warning information to be notified based on the priority orders of said plurality of warning information, whether said plurality of warning information are to be notified, and the number of errors capable of being displayed on the display unit, and updating display on the display unit based on the determination result.

24. A program for causing a computer to execute a control method of claim 13.

25. A program for causing a computer to execute a control method of claim 21.
